(19) United States
(12) Patent Application Publication
(10) Pub. No.: US 2010/0281042 A1
(43) Pub. Date: Nov. 4, 2010

(54) Method and System for Transforming and Delivering Video File Content for Mobile Devices

(75) Inventors: Edwin D. Windes, Naperville, IL (US); Lam Ping To, Barrington, IL (US); Samuel Ying Cheung, Issaquah, WA (US); Xinfeng Ma, Naperville, IL (US); Misha Gorelik, Lake Zurich, IL (US); Thomas Eric Hayosh, Lake Zurich, IL (US); William Frederick Dyer, Cary, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Novarra, Inc.

(21) Appl. No.: 12/611,678

(22) Filed: Nov. 3, 2009

Related U.S. Application Data
(63) Continuation-in-part of application No. 11/869,832, filed on Oct. 10, 2007, now abandoned.
(60) Provisional application No. 60/889,140, filed on Feb. 9, 2007.
(60) Provisional application No. 61/110,790, filed on Nov. 3, 2008.

(51) Int. Cl. G06F 15/16; G06F 17/30

(52) U.S. Cl. 707/756; 709/203; 707/769; 709/217; 709/231; 707/E17.014

(57) ABSTRACT

A method and system for accessing video file content is provided. When a user encounters a web page with video content, the user can select to view the video content and wait for the server to transcode the video file and to stream the transcoded video file to the user's client device. Alternatively, the user may request that the server transcode the video file and to send the transcoded video file to the user's device, where the transcoded video file will be stored. While waiting for the video to be transcoded, the user may browse other websites, for example. In addition, a user may a request may request that the server transcode the video file and to stream the transcoded video file to the user's device in real-time.

### CROSS REFERENCE TO RELATED APPLICATION

The present patent application claims priority under 35 U.S.C. §120 to U.S. patent application Ser. No. 11/869,832, filed on Oct. 10, 2007, which claims priority under 35 U.S.C. §119(e) to U.S. Patent Application Ser. No. 60/889,140, filed on Feb. 9, 2007, the entire contents of each of which are incorporated herein by reference as if fully set forth in this description. The present patent application also claims priority under 35 U.S.C. §119(e) to U.S. Patent Application Ser. No. 61/110,790, filed on Nov. 3, 2008, the entire contents of which are incorporated herein by reference as if fully set forth in this description.

### FIELD

The present application relates generally to the field of web browsing and network communications. More specifically, the application relates to a system and method for adapting and presenting information from web pages containing content designed for large screen computers to display on a handheld device, such as a cellular telephone or personal digital assistance (PDA).

### BACKGROUND

Today, many worldwide web pages (HTML documents) are available that offer a variety of textual and non-textual content types. As known, a web page is conventionally formatted via a standard page description language such as HyperText Markup Language (HTML), which typically contains text and can reference graphics, sound, animation, and video data. HTML provides for basic document formatting and allows a Web content provider to specify anchors or hypertext links to other Web servers and files. When a user selects a particular hypertext link, a Web browser reads and interprets an address, called a Uniform Resource Locator (URL) associated with the link, connects with a Web server at that address, and initiates an HTTP request for the file identified in the link. The Web server then sends the requested file to the Web browser to interpret and display the file to the user.

On a traditional desktop or laptop computer with a large screen running a standard web browser, HTML content types are easily arranged and displayed for viewing. For example, web sites for searching realtor property listings often deliver a plurality of images for the viewer to quickly scan for a property of interest. When the user identifies a property of interest, they can then read the details associated with the image of that specific property and select that image for further details about the property.

At the same time, the field of communications, and more specifically wireless telecommunications, is currently undergoing a radical expansion. This technological expansion allows an electronic device, such as mobile personal digital assistant (PDA), cellular phone, pager, and other electronic devices to connect to the same information sources, such as a web server or database, as one could with the PC and a PC-based browser. Several small device client browsers are available which deliver content from the web to the handheld devices.

However, these small devices typically lack the screen space or navigation capabilities to display web content intended for display on a desktop or laptop computer. For example, handheld devices may have displays that are small in size compared with desktop computer displays, and thus, portions of Web content, such as images and text that are otherwise displayable on a desktop computer display, may not be displayable on a handheld computing device display unless some modifications are made to the images or text. Particularly, for example, a desktop computer display having an array of 1024 pixels by 1280 pixels may be able to display a large 32 bit per pixel color image. In contrast, a hand-held computing device with a display having an array of 160 pixels by 120 pixels and with the ability to display only about 3 bits per pixel may have to ignore much of the image data. As a result, the image may not be displayed properly, if at all, on the handheld device display unless the size of the image is reduced.

A number of techniques are available for client or handheld browsers to utilize to assist the user in navigating the web pages on the small screens. For example, client browsers may alter the layout of web content, change the positioning of images, or simply not display some web content. Also, files that may not be displayed on a handheld device display can typically be transformed into a format that is displayable and conforms to the limitations of the handheld device. Web content modification, such as image and text modification, is referred to as “transcoding”.

In one particular example, small device browsers are often unable to display video content files in the form as intended for display on a desktop or laptop computer. To transcode video files, a web server or client device may receive the video file and lower a resolution or lower a rate at which frames are displayed so as to enable the client device to display content from the video file to a user. The server or device may also convert the video file from one format to another, such as from an MPEG4 video format to a 3GP format (third generation wireless platform).

Because some Web servers can recognize the type of client device requesting a file, files in a proper format for display on a requesting client device can be generated. However, an enormous number of Web content files can reside within a Web site on the Internet. Furthermore, an enormous number of files are typically added every day to various Web sites. Because of the tremendous number of files available at Web sites, it may be somewhat impractical to create, store, and maintain duplicate Web content files that are displayable on selected computing devices. Accordingly, it would be desirable to be able to transcode and transform Web content upon demand, and thereby adapt web pages for display on a device other than an originally intended device.

### SUMMARY

Within embodiments described below, a method for providing information content to a mobile handheld device is disclosed. The method includes receiving the information content from an information source and detecting a video file within the information content based on a video file indicator. The method also includes replacing the video file in the converted content with a reference link to the video file, and sending to the device the information content including the link to the video file in a format for display on the device. Further, the method provides transcoding a portion of the video file from the information content such that the transcoded video file is converted to a format capable of being displayed on the device. In addition, the method streams the transcoded video file to the device before transcoding all of the video file from the information content.

In another embodiment, a transformation system for providing information content to a mobile device is disclosed. The system includes a processor and a database that may be connected through a communication network. The processor executes software applications stored in memory that include a server browser for (i) receiving information content from an information source that includes a reference to a video file, (ii) transcoding a portion of the video file into a format that is displayable on a mobile device, and (iii) streaming the portion of the transcoded video file to the mobile device. A portion of the video from the information content and the transcoded video may be one or more data packets. Alternatively, the database stores (i) a set of unique keys that are mapped to a set of electronic addresses, and (ii) one or more video files that are capable of being displayed on the mobile device.

These and other aspects will become apparent to those of ordinary skill in the art by reading the following detailed description, with reference where appropriate to the accompanying drawings. Further, it should be understood that the embodiments noted herein are not intended to limit the scope of the invention as claimed.

### BRIEF DESCRIPTION OF FIGURES

FIG. 1A is a diagram illustrating an example system for accessing, adapting, and presenting video content to electronic devices.

FIG. 1B is another diagram illustrating an example system for accessing, adapting, and presenting video content to electronic devices.

FIG. 2 is a flowchart depicting example functional steps for an example method of processing video content for display on a client device.

FIG. 3A is a block diagram illustrating one example of a server for performing the method depicted in the flowchart of FIG. 2.

FIG. 3B is another block diagram illustrating one example of a server for performing the method depicted in the flowchart of FIG. 2.

FIG. 4 illustrates an example flow diagram that illustrates a sequence of actions performed within the system of FIG. 1.

FIGS. 5-8 illustrate example conceptual screen shots as seen on the client device when executing methods described herein.

FIG. 9 illustrates one example of a system such as that shown in FIG. 1 with multiple servers.

FIG. 10 is a flowchart depicting a set of example functional steps for an example method of transforming information content and processing video content for display on a client device.

FIG. 11 is a flowchart depicting another set example functional steps for an example method of transforming information content for display on a client device.

FIG. 12-14 are flowcharts depicting a set of example functional steps for an example method of relating an address of a video file from information content to an address of a transcoded video file.

FIG. 15 is a flowchart depicting a set of example functional steps for an example method of displaying a transcoded video file on a mobile handheld device.

### DETAILED DESCRIPTION

The present application provides a manner of converting information content for display on handheld or mobile devices. Some information content includes video files, which certain devices may lack decoding software and capability to view. Within embodiments discussed below, video files are adapted to be presented to a user on a handheld device. Once a user selects a video file to view from a web page, a server will retrieve and convert the video file to a format that is displayable on the handheld device. In some embodiments, the server will then notify the user (e.g., via an SMS or push message) that the video conversion is complete, and the SMS or Push message will include a link to allow the user to watch the video. In other embodiments, the server may stream the converted video to a user in real-time. The server may also maintain a “My Videos” page where a user can access or watch all the videos that the user has requested to be converted.

Within other embodiments, if a user browses to a video that another user has already had converted, the user may immediately be able to watch the video, assuming that the handheld device is capable of displaying the converted video. Thus, converted videos will be cached by the server. In addition, converted videos can be exchanged between servers within a system so that a number of servers now have a copy of the transcoded video, if for example, the video has been requested a given number of times.

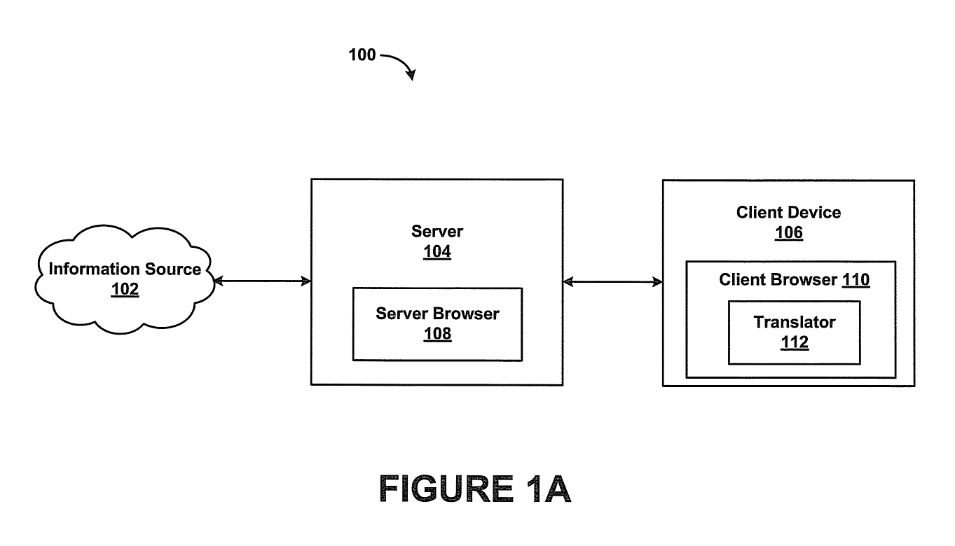

Referring now to FIG. 1A, a high-level diagram is shown illustrating an example system 100 for accessing, adapting, and presenting information content to electronic devices. The system 100 includes an information source 102, a server 104 and a client device 106.

The information source 102 includes any type of device such as a web server, application server, database or other backend system, or any interface to an information provider. The information source 102 provides information content expressed in a markup language, such as those markup languages known in the art including Hypertext Markup Language (HTML), Extensible Markup Language (XML) with or without Extensible Style Sheets (XSL), VoiceXML, Extensible Hypertext Markup Language (XHTML), or Wireless Markup Language (WML). Furthermore, the information content can reference images, video, or audio information to be provided by the information source 102.

The information source 102 can be accessed through any type of network by the server 104 via a server browser 108. The server browser 108 may communicate with the client device over any type of network through a client browser 110. The server browser 108 acts as a proxy between the client browser 110 and the information source 102 of web page content for viewing. The server browser 108 may operate as a client of the information source 102 to retrieve the information content. For example, using a known suite of communications protocols such as Transmission Control Protocol/Internet Protocol (TCP/IP), the server browser 108 can issue a Hypertext Transfer Protocol (HTTP) request to the information source 102. By utilizing HTTP requests, such as is known in the art, the server browser 108 can access information content, including applications, static and dynamic content, at the information source 102.

The server browser 108 and the client browser 110 may reside on the same platform or may be separate from each other. For example, the server browser 108 might be hosted on a back-end server, and the client browser 110 might be hosted on a hand-held electronic device, as shown in FIG. 1. However, it should be understood that the server browser 108 and client browser 110 can be hosted on the same platform such as on an electronic device, especially if the platform or electronic device has the appropriate hardware and network capabilities. Thus, within many embodiments herein, functionality may be described as being part of the client browser 110 or as being part of the server browser 108. It should be understood that the client device 106 and the server 104 may co-exist on the same device, and thus functionality of either can be substituted by each other. Thus, the client browser 110 may perform functions explained as being performed by the server browser 108, and the server browser 108 may perform functions explained as being performed by the client browser 110. By utilizing the server and client browser, smaller electronic devices with limited hardware capability can access feature rich information or data.

Generally, the server 104 and the client device 106 include a central processing unit, a memory (a primary and/or secondary memory unit), an input interface for receiving data, an input interface for receiving input signals from one or more input devices (for example, a keyboard, mouse, etc.), and an output interface for communications with an output device (for example, a monitor). In general, it should be understood that the server 104 and the client device 106 could include hardware objects developed using integrated circuit development technologies, or yet via some other methods, or the combination of hardware and software objects that could be ordered, parameterized, and connected in a software environment to implement different functions described herein. Also, the hardware objects could communicate using electrical signals, with states of the signals representing different data. It should also be noted that the server 104 and the client device 106 generally execute application programs resident at the server 104 and the client device 106 under the control of an operating system. The application programs, such as the server browser 108 and the client browser 110, may be stored on memory within the server 104 and the client device 106 and may be provided using machine language instructions or software with object-oriented instructions, such as the Java programming language. However, other programming languages (such as the C++ programming language for instance) could be used as well.

As an example, the client browser 110 may reside on the client device 106, which may be an electronic device including any of a personal computer (PC), wireless telephone, personal digital assistant (PDA), hand-held computer, network appliance, and a wide variety of other types of electronic devices that might have navigational capability (e.g., keyboard, touch screen, mouse, etc.) and an optional display for viewing downloaded information content. Furthermore, the client device 106 can include any type of device that has the capability to utilize speech synthesis markups such as W3C Voice Extensible Markup Language (VoiceXML). One skilled in the art of computer systems will understand that the example embodiments are not limited to any particular class or model of computer employed for the client device 106 and will be able to select an appropriate system.

To provide an example illustration, assume that a PDA hosts a client browser 110, a PC hosts the server browser 108, and the PDA and PC are both connected to an Ethernet network. Then, the client browser 110 and the server browser 108 could perform information transactions over the Ethernet network. Such transactions would utilize Ethernet or similarly IEEE 802.3 protocols. Nevertheless, in this example, the client and server browsers communicate over a wired network. The communications might also include a wireless network such as a local area wireless network (LAWN) or wireless local area network (WLAN). Moreover, the communications might include wireless networks that utilize other known protocols and technologies such as Bluetooth, wireless application protocol (WAP), time division multiple access (TDMA), or code division multiple access (CDMA).

Referring again to FIG. 1, the client browser 110 can send a request for information to the server browser 108. The client browser 110 may include an event translator 112 to convert a request/response protocol, such as an HTTP request, from the client browser 110 (e.g., WML, XHTML, cHTML, etc.) to an event that the server browser 108 recognizes. The translation process could include event information, content information, and the context of the event such that transactions between the client browser 110 and the information source 102 (e.g. HTML form submission) are preserved.

Information content from the information source 102 is retrieved and can be tailored for use on the client browser 110 by the server browser 108. Alternatively, the server browser 108 may retrieve the information and send the information to the client browser 110, which itself tailors the information appropriately for viewing. Content transformations may be necessary since the requested content (e.g., a video file) could have been initially designed for viewing on a large screen of a PC, rather than on a limited screen size of a handheld device. As a result, either the server browser 108 or the client browser 110 can perform information content transformations or apply device specific style sheets to aid in presentation (e.g., display or voice) and navigation (e.g., keyboard, touch screen, or scrolling), and perform content grouping for electronic devices that accepts data in limited quantities.

To deliver these capabilities, the server browser 108 or client browser 110 may include modules (not shown) including a user agent, cookie handler, DOM, script executor, normalizer, and serializer, for example. Additional information pertaining to information content transformation or customization is included in U.S. Pat. No. 7,072,984, entitled “System and method for accessing customized information over the internet using a browser for a plurality of electronic devices,” U.S. patent application Ser. No. 10/280,263, entitled “System and Method for Displaying Information Content with Selective Horizontal Scrolling,” U.S. patent application Ser. No. 09/843,036, entitled “System and Method for Adapting Information Content for an Electronic Device,” U.S. patent application Ser. No. 11/526,992, entitled “System and Method for Web Navigation Using Images,” and U.S. patent application Ser. No. (Attorney docket no. 07-107-A), entitled “Method and System for Converting Interactive Animated Information Content for Display on Mobile Devices,” the entire contents of each of which are incorporated herein by reference as if fully set forth in this description.

Many different content transformations can occur based on the information present within a requested web page. For example, video files may be included within web page content and will be transformed for viewing on the client device.

The system 100 includes software (within the client browser 110 or the server browser 108) for transcoding or converting video files into a format for display on the client device 106. As used herein, a video file may be a collection of frames of content for viewing in a sequential display, for example, to provide for animation on a screen. The video file may be in many formats, such as those known in the art like a Flash FLV file, wmv file, real file, MPEG, etc.

The server 104 in the system 100 may transcode both web page content and video file content. Alternatively, additional servers may be implemented to transcode the video file content. FIG. 1B illustrates an alternate configuration of the system in which the server 104 operates to transcode web page content, and video transcoding servers 114 are used to transcode video file content. A video database 116 may also be included to store transcoded video files.

Modifying digital video from a digital video stream having one characteristic to a video stream having a different characteristic is referred to generally as video transcoding, and the video file may be transcoded into a format for display on the client device 106 using many different techniques. Examples of different characteristics include video encoding format (e.g. MPEG1 and MPEG2) and data rates, such as affected by different quantization values. When all the video information of one video stream is maintained during a transcoding, a video stream lossless transcoding is said to occur. For Lossless transcoding to occur, it may be necessary that that the bandwidth available to the second video stream is sufficient to support the data present in the original video stream. In one example, lossless video transcoding between video encoding formats can be accomplished by decoding a first video stream having a first video encoding format to generate rendered data (image data), followed by encoding the rendered data to generate a second video data stream having a second video encoding format.

Other examples of transcoding include a video file in an MPEG2 format being transformed for viewing on the client device 106 by lowering the resolution of the video or lowering the frames per second display rate, by removing some of the frames. Specifically, the MPEG2 stream that was broadcast for television receivers can be transformed to a low-resolution stream, such as an MPEG4 stream. A transcoder can receive the MPEG2 stream and decompress compressed video data contained in the MPEG2 stream. The transcoder can then convert the received video data to, for example, a resolution of 360 pixels times 240 lines and to 10 frames/second for the mobile client device, for example.

In addition, transcoding may include changing the video size from one size to another (also referred to as scaling). This typically involves taking a larger video and scaling the video down to a smaller size to reduce an amount of bandwidth required to send the video to the client, and to ensure that the client is able to display the resulting video. Since many clients fail when receiving a video size that is too large, sending a video that is too large may result in entirely wasted bandwidth. Thus, determining a correct scaling factor for each mobile device can be useful.

Other transcoding techniques involve compression of the video files. Most video files use some type of compression to reduce the size. A full size video in its raw format would be too large for many devices. Hence “codecs” or types of compression algorithms are used to reduce the size of the video into a file format that can be decoded later. However when such a process is performed, quality can be degraded and some codecs are even “lossy” to reduce the amount of data needed to display the video. This is usually performed by digitizing a first frame of a video into data known as an I-frame and then comparing the first frame to a next frame. Only the differences between the two frames are recorded into a P-frame. In this manner, not all the frames have to be digitized, but only the differences between the frames, which results in less to data being used to store the video. Other I-frames may also be sent at some interval to allow recovery from any data corruption that may have occurred during transmission.

Since many different codecs or types of compression exist for video (both for the visual and audible components of the video file), it can be helpful to know which clients support certain codecs. Detecting which clients support which formats allows for selecting a best possible video quality to be sent to a specific client. For example, AMR-NB (Narrow Band) is a type of audio codec that is optimized to be small in size and good for human voices, however, the codec may not be good quality for music. MP4 Audio, however, is a format that is larger and supported on fewer clients but has been found to be acceptable for music and multimedia.

The transcoded video may be streamed to the client. Streaming allows the video to begin playing without requiring the entire video file to be downloaded. Streaming also allows the client to free up memory used by already viewed portions of the video. Streaming requires splitting up the video file into small packets that could be sent to a client one by one. The process of splitting the video file into packets is called “hinting”, which includes preparing the packets to be split and informing a streaming server how to send the split packets to the client. Many streaming servers require a video file to be hinted prior to streaming the video to clients. A video file that is not hinted may fail to be streamed and a client would therefore receive an error.

In an example embodiment, when a user encounters a web page with video content, the user can select to view the video content and wait for the server to transcode the video file and to stream the transcoded video file to the user's client device. Alternatively, the user may request that the server transcode the video file and to send the transcoded video file to the user's device, where the transcoded video file will be stored. While waiting for the video to be transcoded, the user may browse other websites, for example. The user may then view the video file at a later time that is convenient by accessing a video file “inbox.” Still, as another alternative, the transcoded video file could be stored at the server or at another database, and the server can send a notification to the user's device to indicate that the video file has been transcoded. The user can then access a video file inbox and request that the transcoded video file be sent to the user's mobile device. By having the video file transcoded and stored in the transcoded form, the user can select a time to view the transcoded video file without having to wait for the video to be converted.

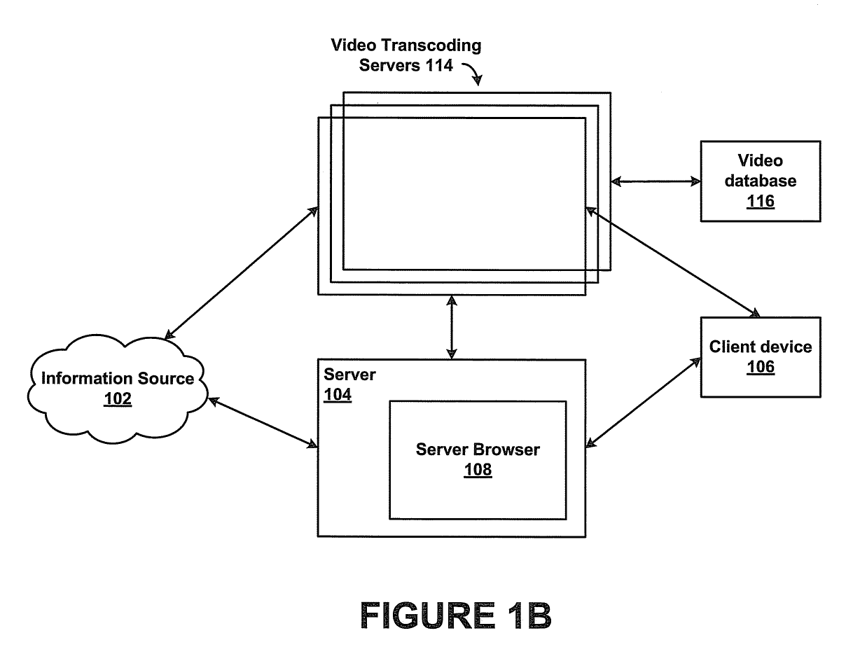

FIG. 2 is a flowchart depicting functional steps for a method 200 of processing information content for display on a client device. It should be understood that each block in this flowchart (and within other flow diagrams presented herein) may represent a module, segment, or portion of computer program code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of the described embodiments.

First, the client browser 110 will send a request for information content to the server browser 108, which contacts the information source 102 to obtain the information content. The server browser 108 will then receive the information content from the information source 102, as shown at block 202. The information content may be a typical web page (e.g., HTML document) including text and images associated therewith. The information content also may include a video file.

After receiving the requested information content including the video file, the server will load the web page and identify content that includes video, as shown at block 204. The server may identify video content within a web page by filtering through all attachments or links to the web page, and noting a type of file associated with the link. For areas of the web page that include video content, the server may generate a reference to the video content in the web page, as shown at block 206. For example, the server will retrieve or generate a snapshot of the video, such as a still image of a first frame of the video, to present to the user. The server will also adapt the web page for viewing on the handheld device and send the web page with the reference to the video content to the client device, as shown at block 208. The server may also include a link selectable by the user of the client device to instruct the server to transcode the video file into a format that may be displayed on the client device.

Upon selection of the link to instruct the server to convert the video file, the server will receive the request, as shown at block 210, and transcode the video file. Videos will be converted based on the capabilities of the client device or capabilities of the client browser. The server will then notify the user that the video conversion is complete, as shown at block 212. The server may notify the user in any number of ways, such as for example, using a Short Message Service (SMS) or Push messaging that includes link to allow the user to watch the video. Thus, the notification may be text messages such as those provided according to the well-known short message service (SMS) protocol, as defined in IS-41 and in Interim Standard 647-A (IS-647-A), as published by the Telecommunication Industry Association, which are both herein incorporated by reference. However, the notification message may be in any form, such as a voice message, a graphical icon message, or any combination of text, graphics, and voice.

The notification message includes an identifier, which links to the associated transcoded video file. The server may place a video file identifier into the notification prior to the server sending the notification message to client device. The client device, in turn, may send the identifier to the server to retrieve the associated transcoded video file. In this manner, the server may send a link to a page, such as a “My Videos” page, where a user can access all the videos that the user has requested to be converted (and that have not expired from the cache).

Once the server has transcoded the video file once for the user, if the user were to browse back to the previous web page including the same video file, instead of being given the option to convert the video file, the server will provide the user with the option to watch the video because the server will have access to the stored transcoded video file (for a desired amount of time). The converted videos will be cached and the amount of time that the converted files are cached will be configurable.

Because the server may store a transcoded form of the video file, if a second user were to browse to the original video and desire to view the video, the second user may be able to view the transcoded video (or otherwise have access to the transcoded video, assuming that the second user's mobile device is capable of displaying the transcoded video) because the server has already performed the conversion. In this manner, the server stores transcoded video files for a limited amount of time, and if a second user were to request one of the video files that had been transcoded during this time, then the server may simply retrieve the stored transcoded video file and provide the transcoded video file to the second user. Short term storage of transcoded video files allows users to view the videos without having to wait for the server to perform the conversion, and allows the server to only store video files that have been recently transcoded so that a large memory bank is not necessary. Using example embodiments, videos will be readily available for other users in a transcoded form because the server preserves the transcoded form of the video file for a desired amount of time.

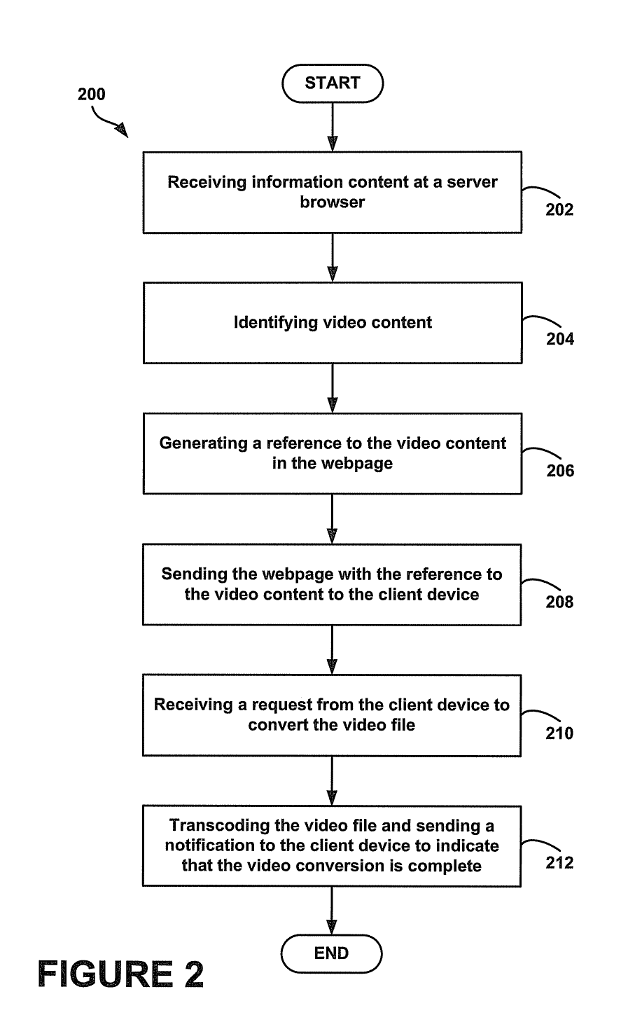

FIG. 3A is a block diagram illustrating one example of a server 300 for performing the method depicted in the flowchart of FIG. 2. The server 300 includes an input interface 302 coupled to a processor 304 and a server browser 306. The server browser 306 may be stored in memory (not shown) so that the processor 304 accesses the memory to execute software or program instructions that enable operation of the server browser 306. The server browser 306 includes components such as a TCP/IP engine 308. The server also includes a video streamer 310 with a video file converter 312 that may be executed through additional software or program instructions by the processor, for example. Alternatively, the video streamer 310 and video file converter 312 may be implemented within portions of the processor 304 as well. The video streamer 310 and video file converter 312 may also reside on a computer separate from the server 300, and when the streamer and converter are separated, the streamer and converter may be referred to as a video transcoding server (as illustrated in FIG. 3B, video transcoding server 316). A single server 300 may request video transcoding from many video transcoding servers. A video database 314 will store the transcoded videos. In the instance in which the video streamer 310 and video file converter 312 reside on a computer separate from the server 300, the server 300 may perform transcoding of web page content, while the video transcoding server 316 performs transcoding of video file content.

The server browser 306 is a software application that is executable by the processor 304 to read an electronic document or electronic data, and render the data into a visual display of text and/or graphics for display. The server browser 306 may include such operating functional components as windows, pull-down menus, buttons, and scroll bars, and thus may be a typical web browser.

The server 300 will receive requests for information from client devices, and will responsively access the information source to retrieve the information. The server 300 will then be operated by the processor 304 to convert the information into a form accessible by the requesting client device. For example, a client device may request a typical web page, and thus the server 300 will access the Internet and retrieve the requested web page and then the processor 304 can convert the web page into a form accessible by the client device. In some instances, the web page will include a movie or video file, and thus the server 300 will retrieve and load the web page on the server browser 306. The processor 304 can then capture a static image of the movie and insert the captured image into the web page during conversion of the web page to a format displayable by the client device. The processor 304 can further access the video file converter 312 to transcode the video file into a format that may be displayed and viewed on the client device. The video file converter 312 will write transcoded videos to the database 314 and the video streamer 310 will read videos from the database 314 when the videos are available. The video streamer 310 will then send the actual video content to the client.

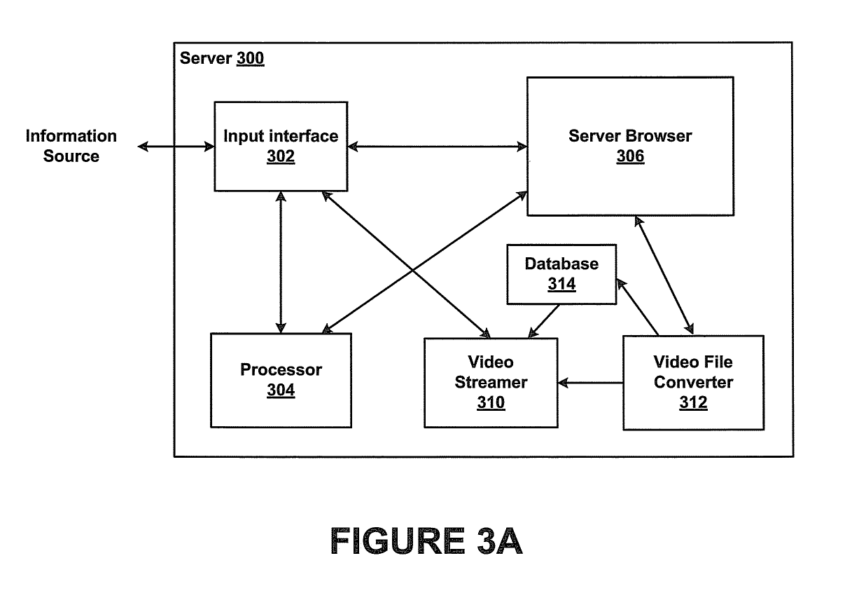

FIG. 4 illustrates an example flow diagram that illustrates a sequence of actions performed within the system of FIG. 1 according to the present application. Initially, as shown, the client device 106 will request an HTML web page. The client device 106 will send the request to the server 104, and the server 104 will retrieve the HTML web page from the information source 102. The server 104 will receive the HTML web page from the information source 102 and will transcode the web page and tailor the web page for viewing on the client device 106. The server 104 then sends the transformed web page to the client device 106. In the instance in which the web page includes a video file or a link to a video file, the server 104 may simply insert a static image from the video file into the web page content. The client device 106 may then request the video file content from the server 104. The server 104 will retrieve the video file content from the information source 102. The server 104 can then transcode the video file, and respond to the client device 106 with a notification indicating that the video file has been transcoded and is ready for viewing on the device. The notification may include a link that may be selected to view the transcoded video file and/or a second link that may be selected to access a video inbox that provides access to transcoded video files that have been requested by a user of the device.

The server may be connected to a short message service center (SMSC), which sends the notification to the client device in the form of an SMS message. An SMSC may function as a store-and-forward system for messages. The system 100 provides the mechanisms required to find a destination client device, such that an SMSC may then transport messages to the destination client device. The SMSC may forward the SMS message to the client device using an SMS delivery point-to-point (SMSDPP) format (e.g., accomplished via the use of “forwardShortMessage” mechanisms as defined in IS-41). However, if the client device is inaccessible at any time during which the SMSC is attempting to deliver a message, the SMSC may then store the message until a later time when the MS becomes accessible. Several mechanisms are available to send notification messages to the client devices through an SMSC. For example, paging networks, specialized software for personnel computer based messaging, and operator bureaus can initiate a notification message.

Alternatively, the server 104 may function as an external short message entity (ESME) as defined in IS-41. The server 104 may generate notification messages indicating that the video file has been transcoded and send the generated messages via a circuit or packet switched network the client device. The notification messages may be text messages such as those provided according to the well-known short message service (SMS) protocol, as defined in IS-41 and in Interim Standard 647-A (IS-647-A), as published by the Telecommunication Industry Association, which are both herein incorporated by reference. However, the notification messages may be in any form, such as a voice message, a graphical icon message, or any combination of text, graphics, and voice.

The notification messages also preferably include identifiers, which link to their associated transcoded video file. For example, the server 104 may place a video file identifier into the notification message prior to the server 104 sending the message to client device. The client device may send the identifier to the server 104 in order to retrieve the associated transcoded video file.

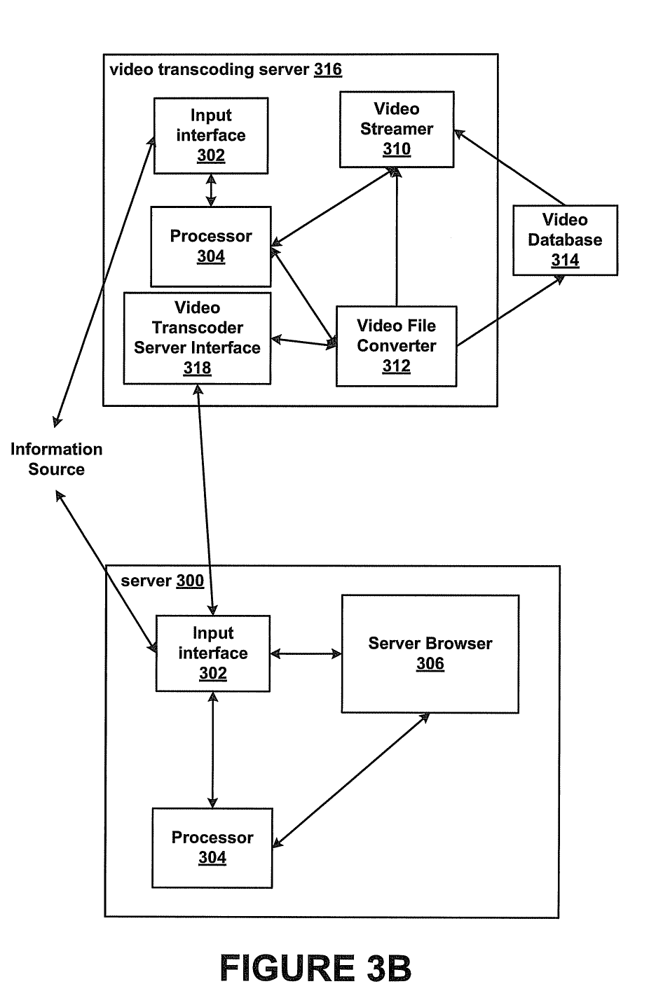

FIGS. 5-8 illustrate conceptual screen shots as seen on the client device when executing methods described herein. For example, FIG. 5 illustrates a conceptual transcoded web page being viewed on a handheld device. The web page, in this example, includes a thumbnail image representing a video file and links that may be selected to either watch the video or convert the video into a format displayable on the handheld device. If the user clicks “Watch Video”, then a native video player will be launched to play the video. The server will stream the video to the client device in real time and convert or transcode the video while doing so. The video may take some time to load on the device, due to delays at the server for converting the video in a format displayable on the client device.

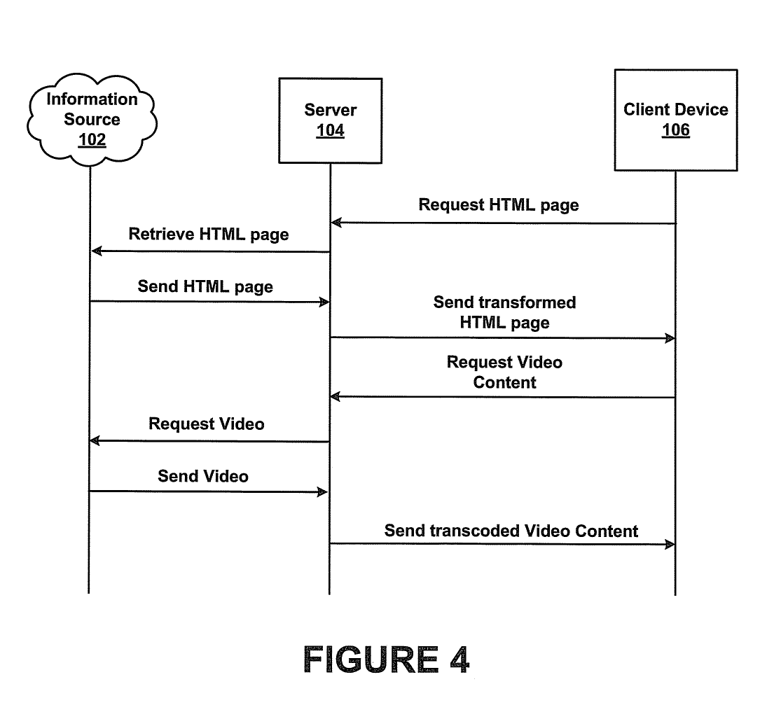

If the user would rather browse other pages or perform other tasks while the server performs the conversion of the video file, the user may click “Convert Video”, as shown in FIG. 6. The server would then begin transcoding the video file, and a message such as that shown in FIG. 6 could be displayed on the client device indicating that the conversion is in progress and the user will be notified when the conversion is complete. The user of the client device may then browse to other web pages while waiting, for example.

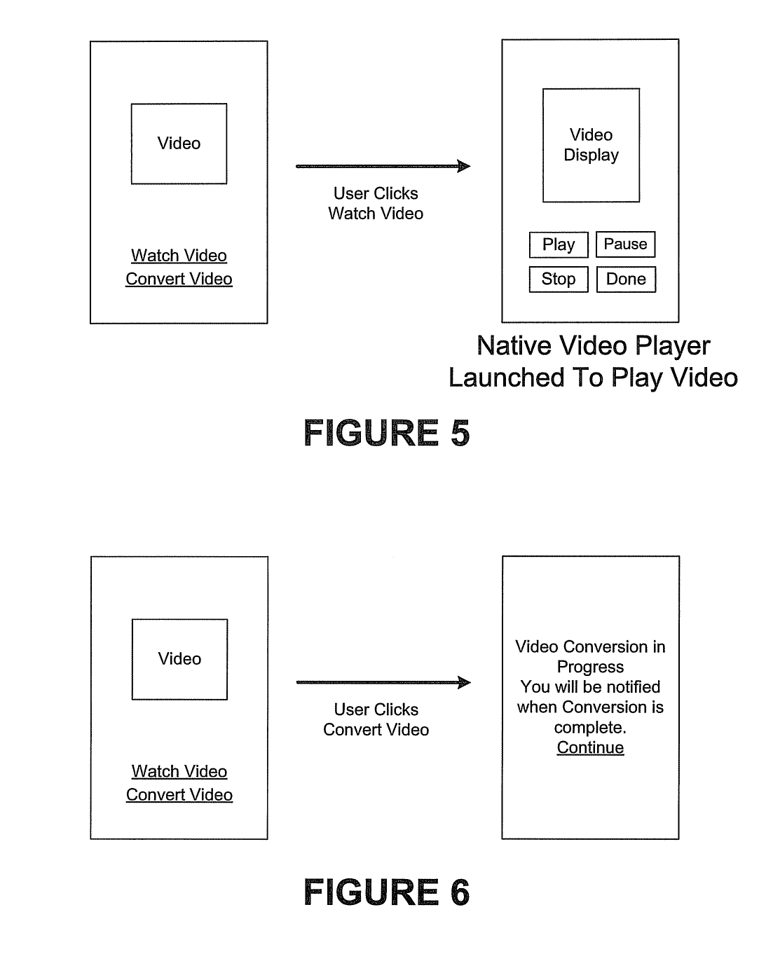

Once the server has completed conversion of the video file, the server will send a notification to the client device. The notification will indicate that the video file has been transcoded and is ready for viewing on the client device, as shown in FIG. 7. The notification will also include a link that may be selected to view the transcoded video file (“Watch Video Now”), and a second link (“My Videos”) that may be selected to access a video inbox that provides access to transcoded video files that have been requested by a user of the device. FIG. 7 illustrates that when the user selects the “Watch Video Now” link, the server will stream the transcoded video to the client device, which will launch a video player to display the video.

The client device includes applications to display the notification messages. For instance, a typical SMS text viewer that displays short text messages, possibly by abbreviating words or sentences, may display the notification messages within the client device. Additionally, the client browser may be able to display the notification messages. Still other graphical user interfaces or textual user interfaces may be employed.

The client device may receive notification messages from the server and display the messages in a list (or other equivalent grouping) to a user of the client device, using an application, such as the client browser. When the client device receives a notification message, the client browser may responsively open to display all messages that the user of the client device has previously and/or currently received. Alternatively, the user may request the client browser to open and after the browser opens, the user may then scroll up or down the list of notification messages and select a message associated with a transcoded video file that the user desires to view.

The notification messages may include (as text or encoded) several parameters or information of the transcoded video file. For example, the notification message may include the video file's name, length, request date, or other characteristics of the video file or website from which the video file was requested.

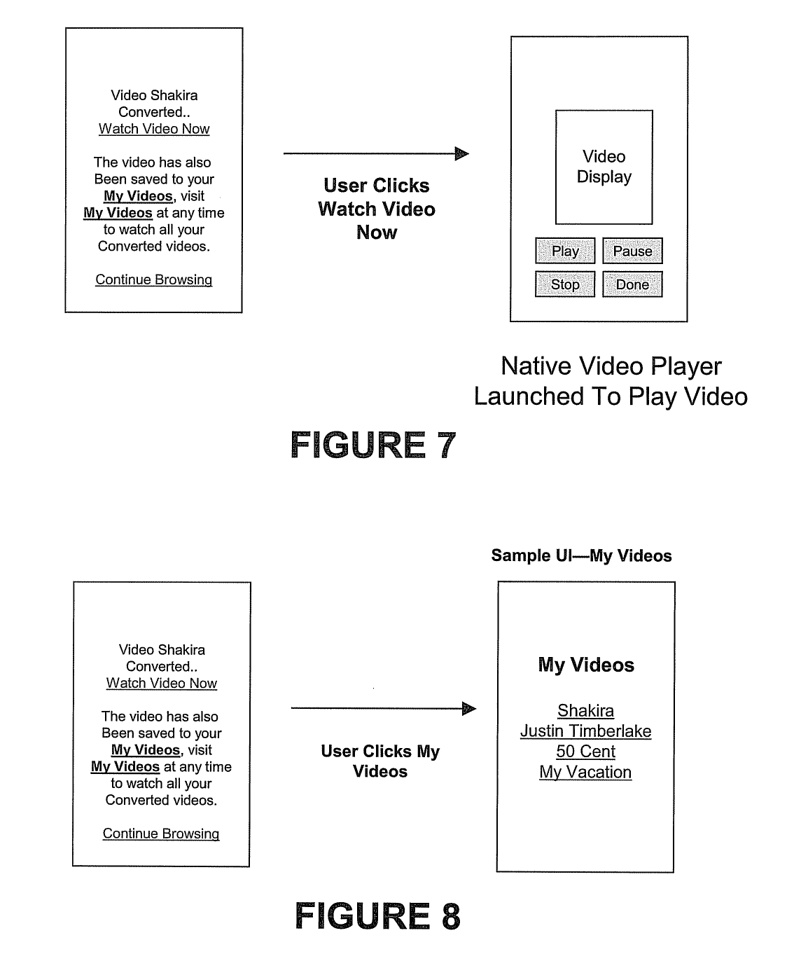

FIG. 8 illustrates that when the user selects the “My Videos” link, the server will connect the client device to the user's Video inbox, which includes links to the currently requested transcoded video file and all other previously requested transcoded video files that are still being stored. The user may then select a specific link to view any of the video files. The server may store the transcoded videos files for the user for a limited amount of time, so that the user will have access to requested video files only for this time. The server may remove a transcoded video file from storage, for example, after a week, so that if a user returns to the user's Video inbox a week later the user will no longer have access to the transcoded video file. Access to transcoded video files would be added and removed from the user's Video inbox on a rolling basis.

Once a user selects a link within a notification message, the client device extracts the identifier from the message and sends the identifier to the server to request the stored transcoded video file. The server will then stream the transcoded video file to the client device using known techniques.

Using the embodiments discussed above, a user can request that a video file be transcoded for viewing on a client device and then return at a later time to the client device to retrieve the transcoded video file. Instead of waiting for the video file to be converted, the user could retrieve a transcoded version of the video file at a later time that was convenient. The transcoded video file would then be available for a limited amount of time within the user's Video inbox.

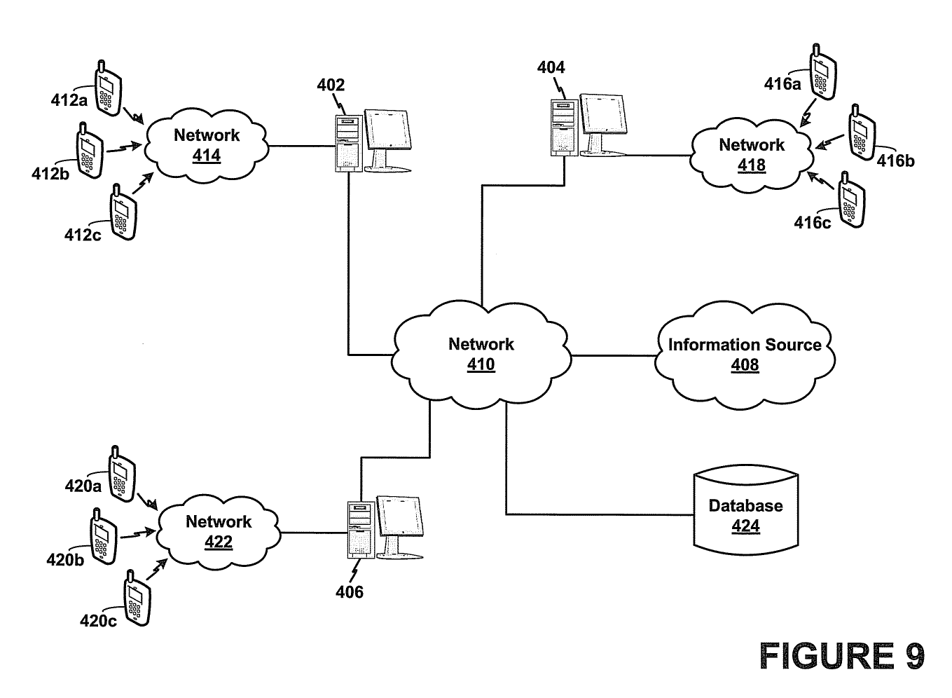

The methods above have been described with reference to a single server and client device system. However, the system may include many servers each of which communicates with many client devices at any given time. FIG. 9 illustrates one embodiment of a system with multiple servers, for example. The system includes servers 402, 404 and 406 each of which is connected to an information source 408 via a network 410. Many client devices communicate with each server individually. For example, client devices 412a-c communicate with server 402a through network 414, client devices 416a-c communicate with server 404a through network 418 and client devices 420a-c communicate with server 406a through network 422.

The networks 414, 418 and 422 may be wireless networks, such as a CDMA network, or wired networks like an Ethernet network. Further, although networks 414, 418 and 422 are shown to be separate networks, the networks 414, 418 and 422 may be the same network or a subset of the same network, so that all client devices 412a-c, 416a-c and 420a-c and servers 402, 404 and 406 communicate over the same network. In this regard, network 410 may be a wired or wireless network and may also be the same network as the networks 414, 418 and 422. Thus, each server and client device cluster may communicate over the same network, for example.

Methods of the present application can be used within the system of FIG. 9 to optimize resources, and lessen wait times for client devices to receive requested information content. It would be desirable for servers within the system of FIG. 9 to only have to transcode video file content one time. As such, in one embodiment, the system in FIG. 9 includes a database 424 to store transcoded video files and each of the servers 402, 404 and 406 may store and retrieve transcoded video files in the database 424 via the network 410.

With the centralized database 424 present in the system, many techniques may be implemented to optimize processing power of the servers. For example, suppose over a short period of time, many client devices request the same video file from the information source 408, and thus each of the servers would have to transcode the same video file multiple times to send transcoded video files to the client devices. The servers can alternatively access the database 424 to see if the video file has already been transcoded and stored, and then simply retrieve the transcoded file and send the transcoded file to the requesting client device.

A server may store every video file that the server transcodes in the database 424, or the server may only store certain transcoded files. For example, the servers may only store transcoded video files once a certain number of requests have been received for the video file so that if the video becomes popular enough (requested e.g., 100 times), then a copy of the transcoded video file can be saved in the database 424. All of the servers would then have access the transcoded video file.

The database 424 may store transcoded video files for a limited amount of time. For example, the database 424 may store videos for about a week, and may remove videos on a first in first out basis.

As another alternative, if one server within the cluster of servers in FIG. 9 were to receive a large number of requests to transcode a certain video file, the server could send a copy of the resulting transcoded video file to all the other servers in the cluster so that each would have a copy on hand and ready to be sent to a requesting client device. In this manner, a client device would have a lower wait time to receive popular video files.

The application further describes embodiments that are example methods to transform web pages so that video content may be viewed on mobile handheld devices that do not support a web sites' video players and that do not have memory and bandwidth necessary to download the videos. Moreover, example methods below stream video in real-time instead of or in addition to sending a Push or SMS message notifying a user that a video is ready for viewing.

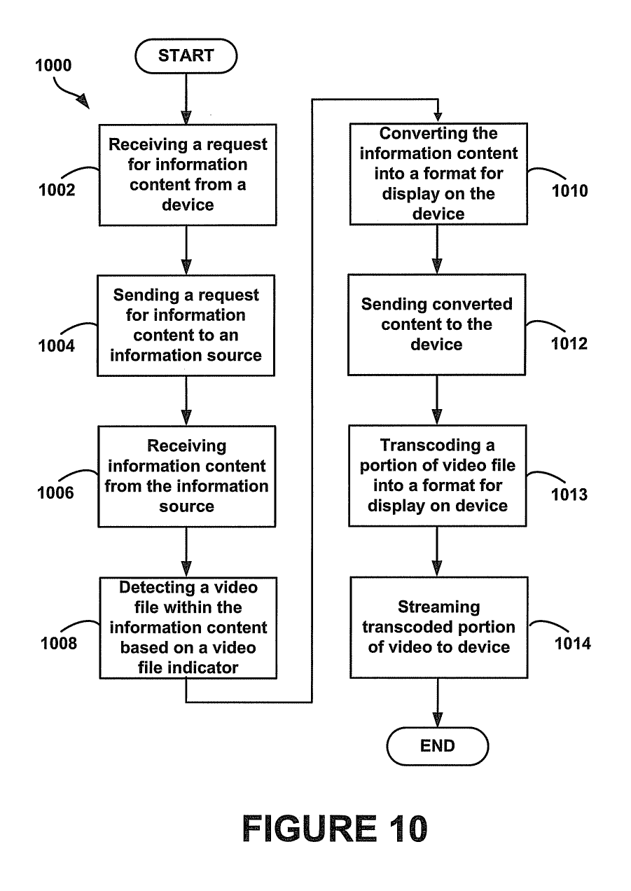

FIGS. 10-15 are flowcharts of example functional steps of example methods for transforming information content and processing video files. It should be understood that each block in this flowchart (and within other flow diagrams presented herein) may represent a module, segment, or portion of computer program code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of the described embodiments.

The example functional steps may be performed by a server as part of a transformation system. Further, the server may interact with a mobile handheld device and an information source over various types of communication networks, as shown in FIG. 1A and FIG. 4. The information source may be one of several different types of devices that may include any device such as a web server, application server, database or other backend system, or any interface to an information provider. The communication network connecting the server and the mobile handheld device may be a mobile telephone network or any other type of wireless network. Alternatively, the communication network connecting the server and the information source may be the Internet, WLAN, or any other type of communication network. Components such as the mobile handheld device, computer, information source, database and communication networks that transform information content and transcode video may comprise a transformation system.

In one embodiment, to provide video in real-time to a mobile handheld device, a server can receive and transcode a portion of a video file, and then stream the transcoded portion to the mobile handheld device. The server may operate on a portion of the video file to provide some content to the mobile handheld device more quickly, instead of receiving an entire video file, transcoding the entire video file, and then sending the transcoded video to mobile handheld device. A server receives portions of the video file as data packets from an information source across a communication network. In such an embodiment, the server may transcode portions of the video file, and stream the transcoded portions of the video file as the server receives one or more data packets but before receiving the entire video file from the information source. This reduces a delay of waiting to receive the entire video file from the information source and then transcoding the entire file before streaming the transcoded video to the mobile handheld device. Thus, the server implements a real-time streaming feature for providing the transcoding video to the mobile handheld device.

FIG. 10 is a flowchart 1000 depicting a set of example functional steps for a method of transforming information content and processing video content for display on a client device. The example method provides video to the client device in real-time. First, a server receives a request for information content from a mobile handheld device across a communication network, as shown in block 1002. For example, when a user loads a web page, a browser on the device may send a request to the server. Subsequently, the server sends a request for the information content to an information source across the communication network, as shown in block 1004. The information source may be a web server operated by an information service provider such as a news agency, entertainment, outlet, or online publisher, for example.

Next, the server receives information content, such as a web page, and associated resources from the information source, as shown in block 1006. The information content may include different types of media such as text, still graphics (e.g. photograph, clip art, etc.), audio, and video. The server may execute any scripts associated with the web page. The server “spoofs” (imitates) capabilities of a desktop browser to cause the scripts to create HTML code needed to create any functions associated with the web page, such as a video player. Once the scripts associated with the information content (e.g., web page) are executed, the server may examine the information content to detect a video file based on a video file indicator, as shown at block 1008. For example, a web page may be searched to identify any HTML tags that can be used to embed video on the web page (e.g., <embed> or <object> tags.)

The server then converts the information content into a format for display on the mobile handheld device, and replaces the video file with a reference link to the video file, as shown in block 1010. Moreover, if the information content included video, the server removes the video file so that the video file may be transcoded separately (see block 1013). For example, web pages to be viewed on the device may be passed through a transformation system that inspects the web pages and converts them for display on the device. The converted information content includes, for example, a reference link that refers to the information content's (web page's) video, once the video is transcoded. Alternatively, the reference link connects to a new web page that may contain the original video file. A reference link to the video is placed in the converted information content, so that when a user selects the reference link, the user can receive the video and start playing the video immediately (real-time). Sending the information content without any conversion may result in the mobile handheld device not being able to display the information content or display the information content in a manner that is not aesthetically appealing to a user.

Consequently, the server converts the information content so that the information content may be viewed in an aesthetically appealing manner within the performance limitations of the mobile handheld device. Further, the server may remove the video file from the information content before converting the information content and hence converts a sufficient portion of non-video content that (e.g. text, individual frame of video, etc.) relates to the video to be viewed/displayed on mobile handheld device so that the user can adequately determine the subject matter of the video. Any remaining non-video content within the information content is loaded secondarily, if at all. Alternatively, the converted information content may contain a link to the remaining content as well. After converting the information content, the server sends the converted information content to the mobile handheld device over the communications network, as shown in block 1012.

Additionally, the server may transcode a portion of the video file from the information content into a format capable of being displayed on the mobile handheld device, as shown in block 1013. A portion of the video file may be one or more data packets received from the information source. Transcoding the video file a portion at a time allows the server to stream video to a user in real-time and not wait to stream the video only after transcoding the entire video file. Further, transcoding portions of the video file may include having the HTML code used to instantiate (load) an original video player being replaced with code needed to play video on a specific device. Many different methods may be used to convert the video. For example, individual frames of the video may be extracted and sent to the client device. Further, video may be converted into many different forms. For example, video may be converted to a 3GPP format for the purpose of delivering video to mobile handsets. During transcoding, a new URL may be created for the converted video. The new URL directs the player on the device to request the video from the server. Once the a portion of the video file is transcoded, the server streams the portion of the transcoded video file to the mobile handheld device in real time, as shown in block 1014.

HTML code that may have been used to embed a video player in an original video web page(s) may be replaced with code that creates a device-appropriate video player. Further, the video may be transformed to fit the device's screen (width and height), and adapted to comply with the device's bandwidth capabilities. Additionally, content within a video website can be reduced to just the video content, so that only the video content is delivered to the handheld device. In this manner, the user of the handheld device can receive the video content more quickly and/or in real-time.

Internet video websites deliver video using various formats and protocols. The video can be viewed in an internet browser running on a personal computer (PC). The web page delivered to the browser contains executable code (JavaScript) that examines the browser's identity and capabilities, and creates HTML code instructing the browser to instantiate (load) an appropriate video player. Information about the video to be played (including a location of the video to be played) is passed to a video player. When the video player is executed, the video player downloads the video and displays the video to the user.

Small devices, such as cell phones, often have a browser, but may not be able to execute the video player because of performance and memory limitations or lack of browser “plug-ins”, for example. To allow the device to play web videos, the information content (e.g., web pages) and the videos may be transformed.

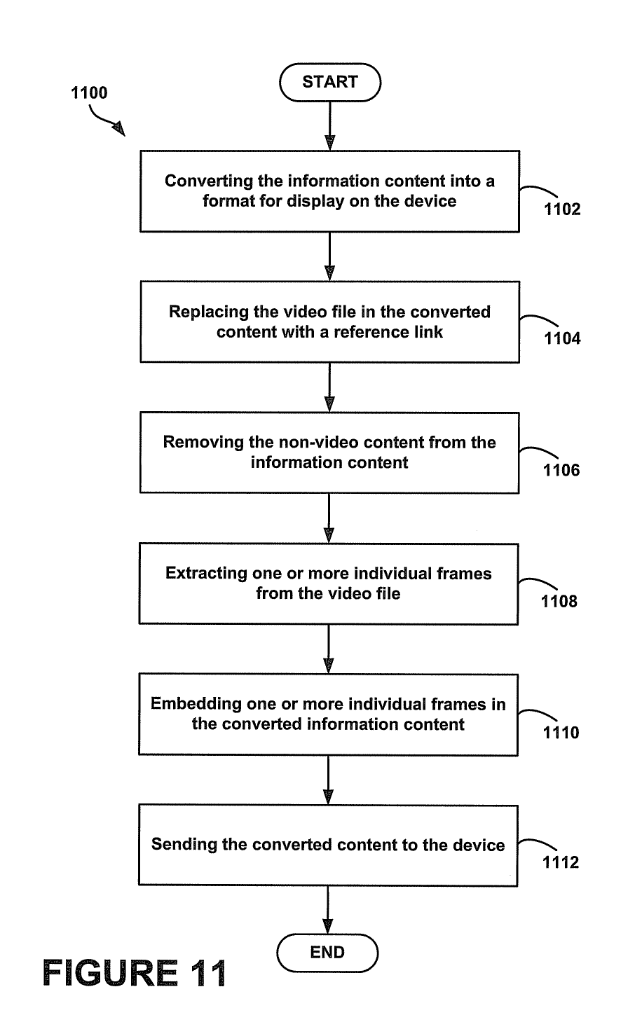

FIG. 11 is a flowchart 1100 depicting another set example functional steps for an example method of transforming information content for display on a client device. First, a server converts information content into a format for display on a mobile handheld device, as shown in block 1102. The information content contains a video file and non-video content (e.g.

text, individual frame of video, still graphics, etc.) The server may convert a sufficient portion of non-video content from the information content to be displayed on the mobile handheld device so that a user may determine the subject matter of the video. Further, the server replaces the video file in the converted content with a reference link, as shown in block 1104. The reference link provides, at some other time, the user of the mobile handheld device an opportunity to further request to view the video file from the information content. In addition, the server removes the remaining portion of the non-video content from the information content, as shown in block 1106. Removing the remaining portion of the non-video content provides efficient use of server resources by only converting sufficient non-video content to convey the subject matter of the video to the user and not waste the resources on converting unnecessary content, for example. Consequently, other server resources may be used on other tasks such as transcoding the video and streaming the transcoded video in real-time.

Additionally, the server extracts one or more individual frames from the video file, as shown in block 1108, and then embeds the individual frames in the converted information content, as shown in block 1110. The server may place the one or more individual frames near the reference link to provide a visual indicator of the subject matter of the video file for the user of the mobile handheld device. Subsequently, the server sends the individual frames in the converted information content to the mobile handheld device, as shown in block 1112.

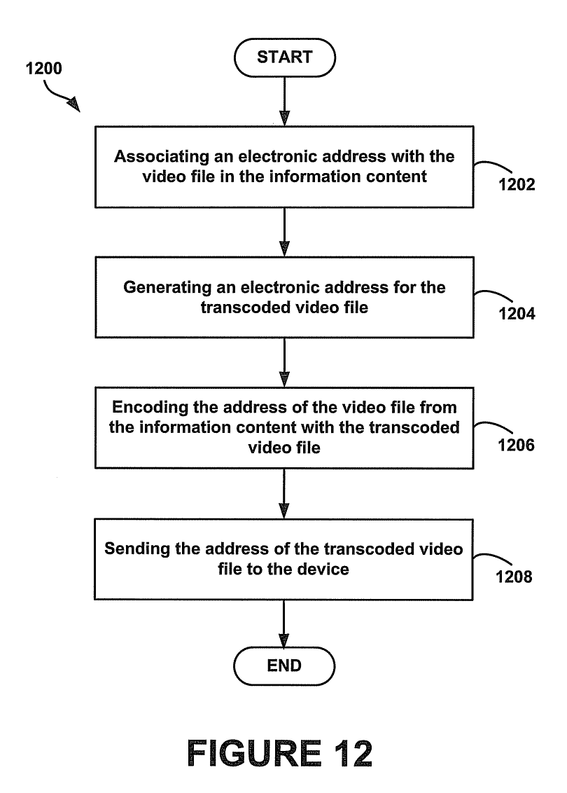

FIG. 12 is a flowchart 1200 depicting a set of example functional steps for an example method of relating an address of a video file from information content to an address of a transcoded video file. A reference link sent by a server in place of a video file may be associated with the address for the transcoded video. For example, if the video file is embedded in information content that is a web page, the address of the video file may be the Uniform Resource Locator (URL) of the web page. Further, the address of the transcoded video may also be a URL. The address of the video from the information content may be encoded in some manner into the address of the transcoded video to improve the processing of the video file so that the video file may be displayed on the mobile handheld device. Thus, an example method may associate the address of the video file from the information content and the address of the transcoded video file with one another.

For example, a web page containing video passes a unique character string that identifies the target video to the video player and a video player converts that identifier string into the correct URL of the target video. There are several ways that this conversion can be performed. On example may be to construct a URL with a video ID (http://wwvv.blah.com/getvideo?id=xxx), and use that URL to download the video. Another example may be to construct a URL which is used to redirect the player to the real video download URL (e.g., HTTP 302 redirect). A further example may be to use the video ID to download a “playlist”—a file which contains information about the video, including the URL used to download the video. These examples are not exhaustive. Different video players will use different techniques for generating the URL of the actual video.

In relating the address to the video file from the information content to the address of the transcoded video file, a server associates an address with the video file in the information content, as shown in block 1202. For example, if the information content is a web page, the server may associate the video with the electronic address (URL) of the web page such and videoID1=http://www.infocontent.com/video1. Subsequently, the server generates an electronic address associated for a transcoded video file, as shown in block 1204. For example, an electronic address may be a URL of the form http://www.transcodedvideo.com/getvideo?id=xxx. Further, the server encodes the electronic address associated with the video file from the information content into the electronic address associated with the transcoded video file, as shown in block 1206. For example, the server may encode the URL of the video into the URL of the transcoded video such as http://www.transcodedvideo.com/getvideo?id=videoID1. Additionally, the servers sends the second electronic address associated with the second video file to the mobile handheld device, as shown in block 1210.

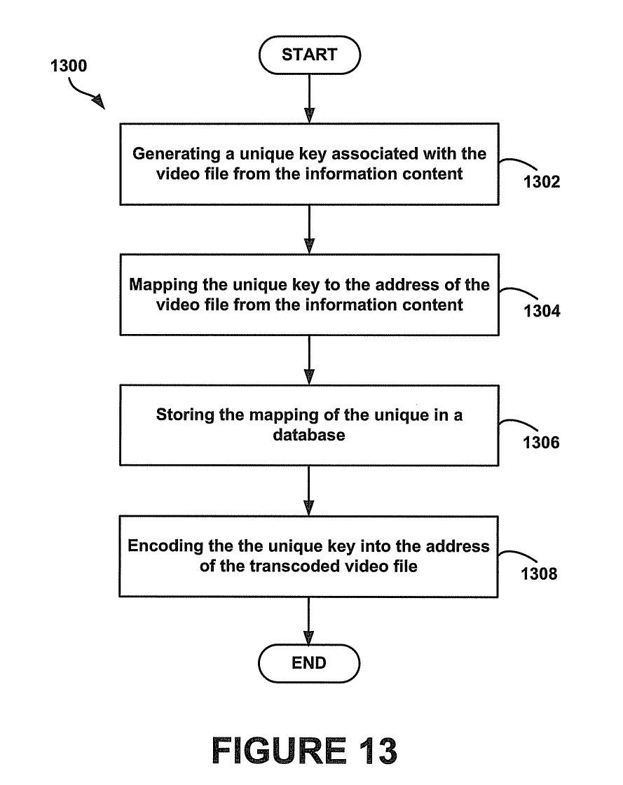

FIG. 13 is a flowchart 1300 depicting another set of example functional steps for an example method of relating an address of a video file from information content to an address of a transcoded video file. The steps of the example method may not only involve a server but also a database. Further, the example method may involve a unique key that relates the address of the video file with the transcoded file. A unique key is part of an encryption scheme and may provide security against unauthorized third parties in ascertaining the address of the video file.

A server generates a unique key associated with the video file from the information content, a shown in block 1302. For example, there may be a unique key for video from a URL http:///www.infocontent1.com and a different unique key for video from a URL http://www.infocontent2.com. Continuing the example, the unique key for video from the URL http:///www.infocontent1.com may be a shift key such that the characters of an alphanumeric string are coded as follows: A=B, B=C, . . . Y=Z, Z=A and 1=2, 2=3, . . . 9=0, 0=9. Further, the server maps the unique key to the electronic address associated with the video file from the information content, as shown in block 1304. For example, the unique key for URL http://www.infocontent1.com. is a shift key and may be given a unique key identifier value of keynum=1. Subsequently, the server stores the mapping of the unique key in a database, as shown in block 1306. For example, the unique key for URL http://www.infocontent1.com is a shift key with unique key identifier keynum=1. The URL http://www.infocontent1.com is stored in the database and is associated with unique key with keynum=1. In addition, the server encodes the unique key into the electronic address associated with the transcoded video file, as shown in block 1308. For example, the server may assign a video identifier for the video from http://www.infocontent1.com such as video ID=AB12YZ09. Applying the shift key, which is the unique key for the URL http://www.infocontent1.com, result in an encoded video ID=BC23ZA10 and may be part of the transcoded URL along with the unique key identifier (keynum) such as http://www.transcodedvideo.com/getvideo?id=BC23ZA10keynum=1.

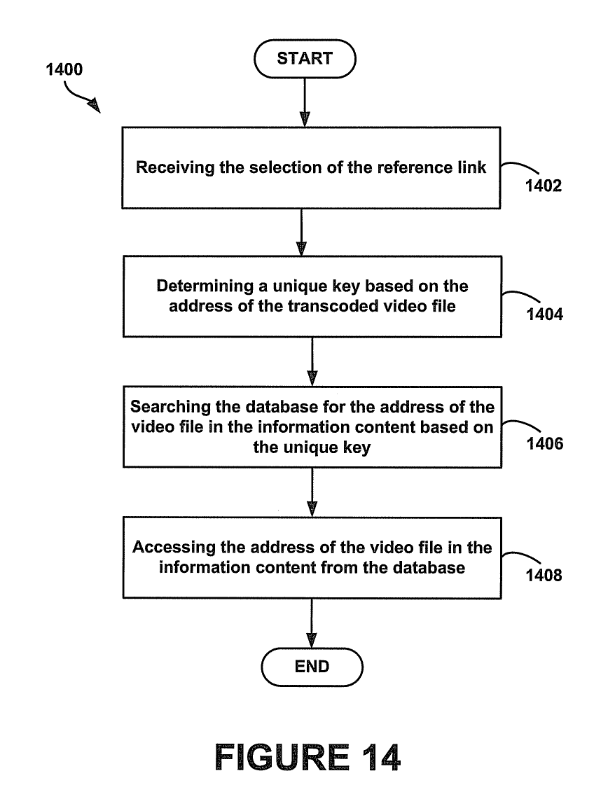

FIG. 14 is a flowchart 1400 depicting another set of example functional steps for an example method of relating an address of a video file from information content to an address of a transcoded video file. Example method 1400 involves a server and database relating the address of the transcoded video to the video file from the information content when a mobile handheld device requests to view the video file. First, the server receives a selection of the reference link on the converted information content from the mobile handheld device, as shown in block 1402. The reference link may have the URL of the transcoded file, for example, http ://www.transcodedvideo.com/getvideo?id=BC23ZA10keynum=1. Further, the server determines a unique key based on the electronic address associated with the transcoded video file, as shown in block 1404. For example, the unique key identifier has a value of keynum=1.

The server would recognize that the unique key for the URL http://www.transcodedvideo.com/getvideo?id=BC23ZA10keynum=1 is a shift key. Thus, the server parses the encoded video identifier videoID=BC23ZA10 from the URL and applies the shift key resulting in a decoded video identifier videoID=AB12YZ09. In addition, the server searches the database for the electronic address associated with the video file from the information content based the unique key, as shown in block 1406. For example, the server searches for shift key and finds that the shift key is associated with URL http://www.infocontent1.com. Thus, the server parses the encoded video identifier videoID=BC23ZA10 from the URL and applies the shift key resulting in a decoded video identifier videoID=AB12YZ09. Thereafter, the server accesses the electronic address associated with the appropriate video file based on the video identifier from a database, as shown in block 1408.

In streaming video, one function of a transformation system may be to determine a type of video player supported by a mobile handheld device and transcode video into a format compatible with the supported video player. Information content such as a web page may have HTML tags that include a source uniform resource locator (URL) used to load a video player (or other executable content). The source URLs may be matched against a list of known video players, and when a match is seen, the transformation system determines the URL of the actual video using rules based on the observed behavior of the player.

The device may support either an “embedded” player, which can play the video inside the device's browser, or a stand-alone player. The embedded player is supported only for browsers with custom support for this feature. Browsers that can support the embedded player send a custom tag in their requests to the server. (They include the “video/3gpp” tag in the “x-novarra-accept” header.). If the embedded video player is supported, the transformation system replaces the original <embed> or <object> tag with a new object tag that causes the embedded player to be loaded, to retrieve the video from a streaming server, and to play the video. The new object tag may include: (1) a “type” attribute that indicates that video should be inserted; (2) a “src” attribute that points to the streaming server, and includes the information used by a video streaming server to find the video; (3) “Width” and “height” attributes scaled to fit the device screen; (4) An “img” used by the player as a preview, until the video begins playing; and (5) An “autoplay” attribute to indicate whether the video should play automatically (without requiring the user to click a “play” button.

If the embedded player is not supported, the transformation system determines whether a native player can be used. Certain browsers may use a native player, and other browsers may send the “video/3gpp-nat” tag in the “x-novarra-accept” header to indicate a preference for the native player.

For the native player, the original <embed> or <object> tags are replaced with a “link” to the video streaming server (which includes the information needed to find the video to stream). The link is displayed with a preview image for the video, and a configurable message informing the user that clicking the link will allow them to watch the video. Clicking the link will cause the device to launch the video in its stand-alone video player.

The original video is converted into a format that is playable on small devices. To do so, the video streaming server is used which can read the original video, convert the original video to a format useable on the device, and “stream” the converted video to the player running on the device.

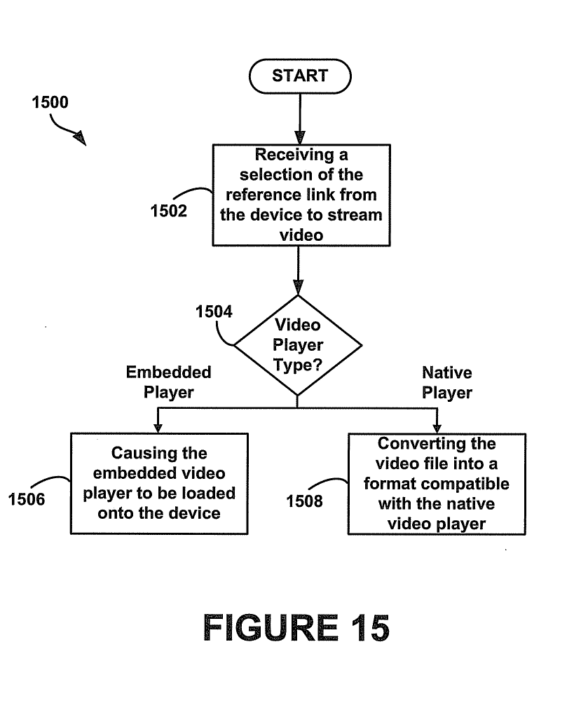

FIG. 15 is a flowchart 1500 depicting a set of example functional steps for an example method of displaying a transcoded video file on a mobile handheld device. There may be several ways to display the transcoded video on the mobile handheld device. A video file from information content may have an embedded video player to play the video file. Many mobile handheld devices may support running the embedded video play to display the video. However, many mobile handheld devices may not support the embedded video player. Alternatively, such mobile handheld devices may have a native video player that may be able to play the transcoded video. Thus, a step in the example method is a server receiving a selection of a reference link from the mobile handheld device to stream the video file from the information content, as shown in block 1502. For example, the reference link provides the server a URL of web page containing the video file. The server may scan the web page to determine whether the web page/video file contains an embedded video player. Subsequently, the server determines the type of video player supported by the mobile handheld device, as shown in block 1504. The mobile handheld device may support several different video players including the embedded video player or the mobile handheld device's native video player. If only the embedded video player is supported then the server causes the embedded video player to be loaded onto the mobile handheld device, as shown in block 1506. However, if only the native video player is supported then the server converts the video file from the information content into a transcoded video such that the converted video file is in a format capable of being displayed on the native video player on the mobile handheld device, as shown in block 1508.

It should be understood that the programs, processes, methods and systems described herein are not related or limited to any particular type of computer or network system (hardware or software), unless indicated otherwise. Various types of general purpose or specialized computer systems may be used with or perform operations in accordance with the teachings described herein.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

In view of the wide variety of embodiments to which the principles of the present application can be applied, it should be understood that the illustrated embodiments are example only, and should not be taken as limiting the scope of the present application. For example, the steps of the flow diagrams may be taken in sequences other than those described, and more or fewer elements may be used in the block diagrams. While various elements of embodiments have been described as being implemented in software, in other embodiments in hardware or firmware implementations may alternatively be used, and vice-versa.

Note that while the present application has been described in the context of a fully functional server and client device system and method, those skilled in the art will appreciate that mechanisms of the present application are capable of being distributed in the form of a computer-readable medium of instructions in a variety of forms, and that the present application applies equally regardless of the particular type of signal bearing media used to actually carry out the distribution. For example, a computer usable medium can include a readable memory device, such as a hard drive device, CD-ROM, a DVD-ROM, or a computer diskette, having computer readable program code segments stored thereon. The computer readable medium can also include a communications or transmission medium, such as, a bus or a communication link, either optical, wired or wireless having program code segments carried thereon as digital or analog data signals. As such, the methods described herein may be embodied in a computer program product that includes one or more computer readable media, as described as being present within the server 104 or the client device 110.

The claims should not be read as limited to the described order or elements unless stated to that effect. Therefore, all embodiments that come within the scope and spirit of the following claims and equivalents thereto are claimed as the invention.

What is claimed is:

1. A method for providing information content to a device, the comprising:
receiving the information content from an information source;
detecting a first video file within the information content based on a video file indicator;
replacing the first video file in the information content with a reference link to the first video file;
sending to the device the information content including the reference link to the first video file in a format for display on the device;
transcoding a portion of the first video file into a second video file, wherein the second video file is converted to a format capable of being displayed on the device; and
streaming the second video file to the device before transcoding all of the first video file.

2. The method according claim 1, further comprising:
receiving a request for the information content from the device; and
sending a request for the information content to an information source.

3. The method according claim 1, wherein each portion of the first video file is one or more data packets.

4. The method according claim 1, further comprising receiving a selection of the reference link from the device to stream the first video file and responsively initiating streaming of the transcoded second video file.

5. The method according claim 1, further comprising:
removing non-video content from the information content;
generating data content based on the non-video content capable of being displayed on the device; and
sending the data content based on the non-video content to the device.

6. The method according to claim 1, further comprising determining a type of video player supported by the device, wherein the type of video player is selected from the group consisting of an embedded video player and a native video player.

7. The method according to claim 6, further comprising causing the embedded video player to be loaded onto the device.

8. The method according to claim 6, further comprising converting the first video file into the second video file, wherein the second video file is in a format capable of being displayed on the native video player on the device.

9. The method of claim 1, further comprising:
extracting one or more individual frames from the first video file; and
sending the one or more individual frames to the device.

10. The method according to claim 1, wherein the first video file is associated with a first electronic address.

11. The method of claim 10, further comprising:
generating a second electronic address associated with the second video file; and
sending the second electronic address associated with the second video file to the device.

12. The method of claim 11, further comprising encoding the first electronic address associated with the first video file into the second electronic address associated with the second video file.

13. The method of claim 12, further comprising:
generating a unique key associated with the first video file;
mapping the unique key to the first electronic address associated with the first video file;
storing the mapping of the unique key in a database;
encoding the unique key into the second electronic address associated with the second video file.

14. The method of claim 13, further comprising determining the first electronic address of the first video file based on the second electronic address associated with the second video file.

15. The method of claim 14, further comprising:
determining the unique key based on the second electronic address associated with the second video file;
searching the database for the first electronic address associated with the first video file based the unique key; and
accessing the first electronic address associated with the first video file from the database.

16. A computer readable medium having stored thereon instructions executable by a computing device to cause the computing device to perform the functions of:
receiving the information content from an information source;
detecting a first video file within the information content based on a video file indicator;
replacing the first video file in the information content with a reference link to the first video file;
sending to the device the information content including the reference link to the first video file in a format for display on the device;
transcoding a portion of the first video file into a second video file, wherein the second video file is converted to a format capable of being displayed on the device; and
streaming the second video file to the device before transcoding all of the first video file.

17. The computer-readable medium of claim 16, wherein the functions further comprise:
generating a unique key associated with the first video file;
mapping the unique key to the first electronic address associated with the first video file;
storing the mapping of the unique key in a database; and
encoding the unique key into the second electronic address associated with the second video file.

18. The computer-readable medium of claim 16, wherein the functions further comprise:
determining the unique key based on the second electronic address associated with the second video file;
searching the database for the first electronic address associated with the first video file based the unique key; and
accessing the first electronic address associated with the first video file from the database.

19. A system for providing information content to a mobile device, the system comprising:
a processor executing software applications stored in memory, the software instructions including a server browser for (i) receiving information content from an information source, wherein the information content includes a video file, (ii) replacing the video file in the information content with a reference link to the video file, (iii) transcoding a portion of the video file into a format that is displayable on a mobile device, and (iv) streaming the portion of the transcoded video file to the mobile device, wherein each portion of the video file and the transcoded video file is one or more data packets.

20. The system according to claim 19, further comprising a database that stores (i) a set of unique keys that are mapped to a set of electronic addresses, and (ii) one or more video files that are capable of being displayed on the mobile device.
